(19) United States
(12) Patent Application Publication
(10) Pub. No.: US 2004/0013939 A1
(43) Pub. Date: Jan. 22, 2004

(54) Arrangement of the connector poles on an accumulator

(76) Inventors: Eberhard Nann, Schmuckersweg (DE); Ulrich Wulf, Waldercker (DE)

Correspondence Address: CANTOR COLBURN, LLP, 55 GRIFFIN ROAD SOUTH, BLOOMFIELD, CT, 06002

(21) Appl. No.: 10/343,481

(22) PCT Filed: Jul. 24, 2001
(86) PCT No.: PCT/EP01/08526

(30) Foreign Application Priority Data
Aug. 7, 2000 (DE) 100-38-472.2

(51) Int. Cl. H01M 2/30; H01M 2/04; H01M 2/08

(52) U.S. Cl. 429/178; 429/175; 429/180

(57) ABSTRACT

Disclosed herein is an accumulator comprising a housing; cells arranged in the housing wherein the cells are interconnected in an electrical series, and wherein the cells comprise a first cell and a last cell; a lid capable of closing the housing; and a connection region comprising: a first connection element; a second connection element; and a coding element for operation in conjunction with a plug element, wherein the coding element is constructed in a region of the lid or a region of the housing that surrounds the first connection element and the second connection element; and further wherein the first connection element is contacted with the first cell, and the second connection element is contacted with the last cell, and further wherein the first connection element and the second connection element are laterally led out of the housing and are parallel to the lid and arranged spatially close to one another.

The present invention pertains to an accumulator battery with cells that are electrically interconnected in series and that are arranged in a housing that is closed by means of a lid, and two connections that are led out of the housing and that are contacted with the first and last cells, respectively.

Accumulators of this type are known as such. Such accumulators are usually lead accumulators in which an appropriate number of cells are arranged in a housing, whereby these cells are electrically interconnected in series. The first and last cells of the electrical series are each connected to a connection pole, which leads out of the housing or lid, so that a positive pole and a negative pole are accessible from outside the housing for operational purposes. In a wide variety of types of accumulators in the form in which they find use in e.g., motor vehicles, the poles are led out from the lid in an upright manner such that they are oriented perpendicularly to the plane of the lid. These [poles] are usually widely separated from one another and they are formed by lead poles that have a large diameter for the purpose of forming a good contact, and they can be contacted with screw-type pole clamps in a time consuming manner. Accumulators are also known in which the contact poles are not led out from the accumulator in a manner in which they are perpendicular to the plane of the lid but, rather, they are led out laterally from the accumulator in a manner in which they are parallel to the plane of the lid. These poles are also widely separated from one another, and they each have to be individually contacted as in the case of those that are described above. As an alternative to lead poles with a large diameter, screw threaded peg poles are known in the case of which contacting takes place by pushing on contact lugs and fixing these in position by means of nuts and similar devices.

In all previously known cases, the type of construction requires at least two lead-through locations through the housing or the lid, as a result of which production becomes expensive. In the case of a finished battery, moreover, each of the connections to the poles, which have been led out of the housing or lid, requires the expenditure of time for installation at different locations of the accumulator.

Starting out from the prior art that has been stipulated above, the problem that forms the basis of the present invention is to further develop an accumulator of this type such that it is simplified and more economical from the manufacturing side, and such that contacting of the connecting poles, which are led out of the accumulator, is more friendly to the operator, safer, and is capable of being achieved without greater installation expense.

In order to solve this problem technically, an accumulator of this type is developed further by way of the feature that the connections are led out laterally, whereby they lie in a plane that is essentially parallel to the lid, and they are arranged spatially close to one another.

In accordance with the solution in accordance with the invention, the connections are led out of the housing in the region of a lateral edge, and they are spatially close to one another. In this way, they lie in a plane that lies essentially parallel to the lid. As a result of this close spatial positioning, it is possible to configure the lead-through region for the connections at essentially one location, as a result of which production is considerably simplified. In addition, the two connections now lie so close together that they are both capable of being contacted simultaneously via one single contacting procedure. The lateral leading out [of the poles] that involves close spatial positioning also gives rise to the feature that comparatively large housing or lid surfaces are directly adjacent, so that these can be utilized for assisting installation and attachment. The close spatial positioning also gives rise to the feature that it is now possible, with simple means and in a simple manner, to cover the connection region with one single cover. In overall terms, the accumulator in accordance with the invention has been simplified from the technical production standpoint, and it is friendlier to the operator and in terms of installation.

A lateral recess is advantageously formed in the lid, whereby the contacts are positioned in this recess in a manner such that they are arranged in a recumbent fashion. Thus the contacts no longer project freely outward from the region of the accumulator's housing, and they are therefore protected from damage. Moreover, they lie parallel to a very large surface region of the housing or lid, so that this can serve for guidance purposes during contacting, and for support purposes during attachment. As a result of the construction of the lid, an insulation cross-piece can be formed between the contacts that are spatially closely positioned relative to one another.

The proposal is made that the cells in the housing be arranged and interconnected, with special advantage, in such a way that the cells that are located nearest to the connections constitute the first and last cells, respectively, that are to be contacted with the connections. In this way, accumulator manufacture is simplified, and the contacting pathways in the interior of the housing between the connections and the respective cells are very short. Lead elbows can advantageously be arranged in a simple manner on the lead grids of the respective cells, whereby these lead elbows project outward into the region of the recess. In accordance with one proposal of the invention, the connections can be brass pegs that are connected to connecting elbows that are constructed with very short dimensions. The arrangement of the connections in the lid's lateral recess in the case of close spatial positioning permits the use of a simple cover flap in order to seal off or, as the case may be, make accessible the entire connection region by means of a single handle. Thus the connections are arranged in a completely protected fashion within the entire contours of the housing during storage and transportation, and they are therefore safeguarded from damage.

For the first time, the connections' arrangement in accordance with the invention now permits the use of a plug element for contacting the connections in order to operate the accumulator. Such a plug element can have plug sheaths in the case of utilization with brass pegs as the connection poles. The plug's housing can be positioned and stored on the side of the housing or the lid in the region of the connections in such a way that, on the one hand, a safe connection is made and that, on the other hand, safe fixing in position of the connection is ensured.

In accordance with a further advantageous proposal of the invention, coding elements can be arranged in the housing or lid region that surrounds the connections, whereby these coding elements operate in conjunction with corresponding regions of the plug housing. As a result, contacting that is safe in regard to polarity can be guaranteed since the coding elements rule out erroneous contacting.

The accumulator in accordance with the invention is advantageously a 36 volt accumulator in the case of which the connections are led out, essentially parallel to the arrangement of the stack of cells, in a central region of an edge on the side where the lid is located.

Accumulators of this type are further developed to such an extent via the invention that the manufacture and installation of such an accumulator are simplified as a result of leading out the connections in a spatially closely positioned manner because now the lead-through regions need no longer be implemented in a spatially restricted manner at one location. Moreover, contacting the connections for operation is simplified considerably and, overall, the accumulator is more user-friendly in terms of operation, and it is safer.

Additional advantages and characteristic features of the invention will arise from the following description, based on the diagrams. The following aspects are shown in this regard.

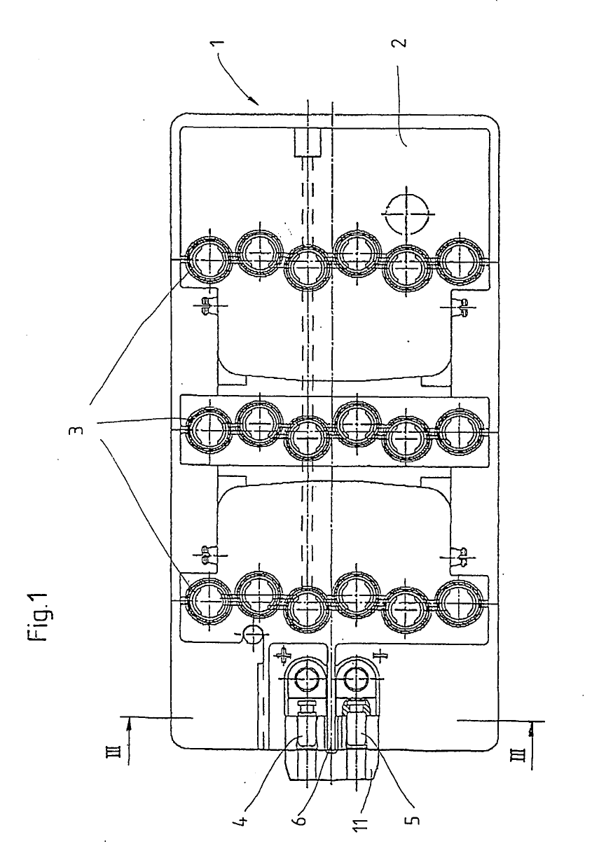

FIG. 1: shows a plan view onto an example of a design of an accumulator;

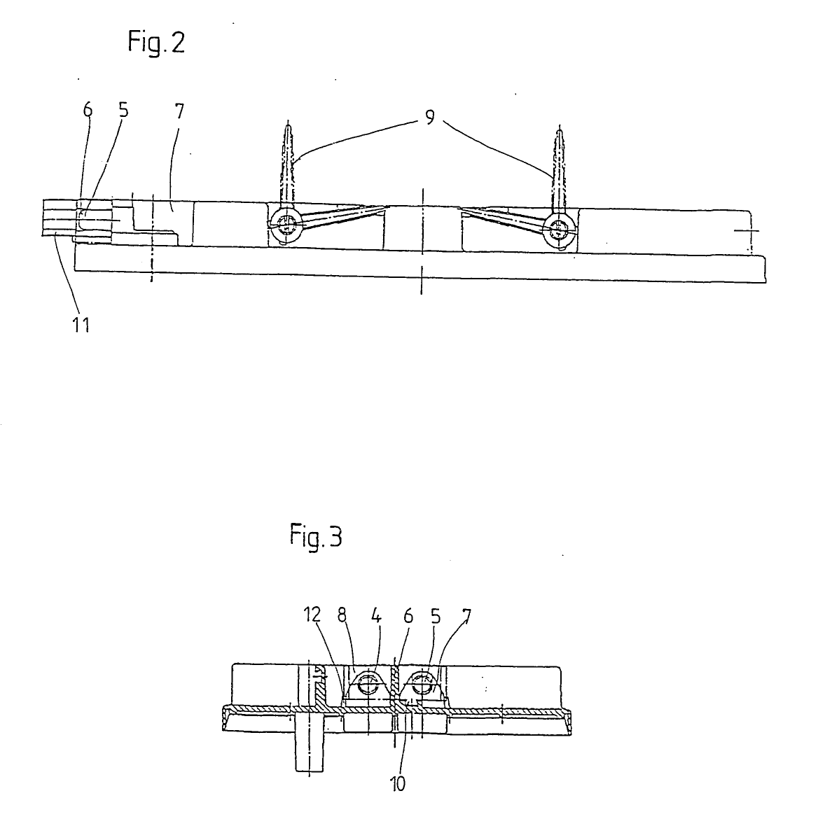

FIG. 2: shows a lateral view of the lid region of the accumulator in accordance with FIG. 1, and

FIG. 3: shows a partially sectioned lateral view of the lid of the accumulator in the connection region in accordance with III-III in FIG. 1.

FIG. 1 shows a plan view onto an accumulator 1, whereby the openings 3 to the cells, which are arranged below, are constructed in the lid 2. In the example of a design that is shown, a 36 volt accumulator is equipped with 18 cell packets that are arranged in three stacks, whereby the cell packets are interconnected in an electrically serial manner in such a way that two central cells, which are located in an edge region, form the first and last cells, respectively, of the series. A positive pole 4 and a negative pole 5 are arranged on these cells, whereby these poles are insulated from each other via an insulation cross-piece 6. The feature emerges from FIG. 3 that the insulation cross-piece is constructed in an integrated manner as a result of the assembly of the lid in the form of an injection molded component. The connection elbows 7, 8, which are preferably lead elbows and which are connected to the lead grids of corresponding cells, can be seen in FIGS. 2 and 3. In accordance with FIG. 2, handle elements 8 are arranged in the lid and can be swiveled.

A plug 11, which can be seen in FIGS. 1 and 2, comprises a plug housing in which connection sockets have been arranged that are capable of being plugged onto the connection pegs. The connections themselves are constructed in the form of brass pegs 4, 5 that have a diameter of e.g., 10 mm and that are connected to the connection elbows 7, 8. They [the contacts] are arranged within the housing in a such a way that their contours are protected, and the housing and plug conceal one another over a large area when making contact, as a result of which contact is assured, and conduction is provided. A coding groove 10 in the region of the connecting pieces prevents erroneous connection. Other guidance cross-pieces 12 or similar arrangements can also be used for coding purposes.

As a result of the spatially close arrangement of the connections 4, 5 via the elbow pieces 7, 8 at the last cells of the electrical series of cells that has been assembled, short installation routes arise and [as a result of] the close spatial positioning of the connections 4, 5 relative to one another, the housing lead-through region is restricted to one location, and it is minimized in terms of size. A lid, which is not shown, permits the safe covering of the connection region in a simple manner. In overall terms, the accumulator that is shown has been simplified considerably in regard to manufacture and installation, and it has been improved considerably in regard to contacting for operational purposes and in regard to safety.

The example of a design that has been described serves merely for elucidation and is non-limitative.

### LIST OF REFERENCE NUMBERS

1 Accumulator

2 Lid

3 Opening

4 Connection

5 Connection

6 Cross-piece

7 Connecting elbow

8 Connecting elbow

9 Handle

10 Groove

11 Plug

12 Cross-piece

Claims for patent protection

1. Accumulator with cells, which are electrically interconnected in series and which are arranged in a housing that is closed by means of a lid, and two connections that are led out of the housing and that are contacted with the first and last cells, respectively, characterized by the feature that the connections are led out laterally, whereby they lie in a plane that is essentially parallel to the lid, and they are arranged spatially close to one another.

2. Accumulator in accordance with claim 1, characterized by the feature that the contacts are arranged in a lateral recess that is arranged in the lid.

3. Accumulator in accordance with one of the preceding claims, characterized by the feature that an insulation cross-piece is arranged between the two connections.

4. Accumulator in accordance with one of the preceding claims, characterized by the feature that the cells in the housing are arranged and electrically interconnected in such a way that the cells that are located nearest to the connections constitute the first and last cells, respectively.

5. Accumulator in accordance with one of the preceding claims, characterized by the feature that the connections are brass pegs.

6. Accumulator in accordance with one of the preceding claims, characterized by the feature that the connections are contacted with the cell in question via lead elbows.

7. Accumulator in accordance with one of the preceding claims, characterized by the feature that coding elements are constructed in the lid or housing region that surrounds the connections, whereby these coding elements are for operation in conjunction with a plug element.

8. Accumulator in accordance with one of the preceding claims, characterized by the feature that the connection region is capable of being sealed off with a cover.

9. Accumulator in accordance with one of the preceding claims, characterized by the feature that it is a 36 volt accumulator.
